(19) United States
(12) Patent Application Publication
(10) Pub. No.: US 2009/0017420 A1
(43) Pub. Date: Jan. 15, 2009

(54) Gingival Cord Applicator for Dental Crown Preparation

(76) Inventor: Saadallah Jabri, Burr Ridge, IL (US)

Correspondence Address: MILLER, MATTHIAS & HULL, ONE NORTH FRANKLIN STREET, SUITE 2350, CHICAGO, IL, 60606, US

(21) Appl. No.: 12/181,454

(22) Filed: Jul. 29, 2008

Related U.S. Application Data
(63) Continuation-in-part of application No. 11/538,603, filed on Oct. 4, 2006.

(51) Int. Cl. A61C 5/14

(52) U.S. Cl. 433/136

(57) ABSTRACT

A gingival cord application tool is also disclosed which facilitates the separation of the gingiva from the tooth prior to the taking of the impression of the prepared tooth for purposes of crown fabrication. A truncated conical dental drill bit is also disclosed to facilitate the preparation of a tooth prior to installation of a dental crown. The drill bit includes a stem connected to an upper disc which, in turn, is connected to a downwardly extending sidewall having a conical configuration. The sidewall terminates at a lower edge and undersurfaces of the sidewall and upper disc are coated with abrasive material, such as diamond particles. The size of the drill bit is chosen for the particular tooth in need of repair and a single downward drilling operation is required to form a truncated conical configuration or crown receiving surface on the tooth. Finally, a measurement gauge is disclosed for measuring the tooth in need of repair and selecting the appropriate size truncated conical dental drill bit.

### CROSS-REFERENCE TO RELATED APPLICATIONS

This is a continuation-in-part to U.S. patent application Ser. No. 11/538,603, filed on Oct. 4, 2006.

### BACKGROUND

1. Technical Field

Various tools and methods are disclosed for facilitating and improving the preparation and installation of dental crowns. More specifically, a truncated cone-shaped drill bit is disclosed which provides an improvement over traditional burr-type drill bits. Further, a measurement gauge is disclosed to ensure proper selection of the truncated cone-shaped drill bit size. Still further, a gingival cord application device is disclosed to facilitate the temporary retraction of the gum from the tooth during the tooth impression procedure. Various methods for employing the above-describe devices are also disclosed.

2. Description of the Related Art

When a patient needs a crown, during the initial office visit, the dentist prepares the tooth to be crowned by removing tooth material with a high-speed drill and a burr-type bit. Relying upon eyesight and expertise, the dentist uses the burr to shape the tooth and make it smaller but wider at the gum line as the prepared tooth is tapered towards the occlusal or chewing surface.

Then, the dentist takes the impression of the dental arch in which the prepared tooth is located, and sends the impression to the lab to have the lab technician make the crown. The impression must be accurate, especially at the gum line of the prepared tooth. It is difficult to obtain an accurate impression without pushing or retracting the gum of the prepared tooth. The dentist must provide the impression material with clean and dry margins, to give a good accurate impression.

Using the impression of the prepared tooth, the lab technician produces a crown that matches the dentist's color and material specifications and sends it to the dentist. At the patient's second visit, the dentist adjusts the crown as necessary before cementing it in place.

In greater detail, with reference to FIGS. 1 and 2, the drill bit that is used for the tooth procedure is a burr-type drill, an example of which is shown in FIG. 1. The drill bit 10 is connected to a traditional dental drilling tool 11 and includes a tapered distal end 12 with a roughened, diamond-coated surface. It takes a great deal of skill to use the drill bit 10 and accurate manner to form a truncated conical surface for receiving the crown that is shown in FIG. 2. Due to the large amount of tooth material that needs to be removed, a substantial amount of time is involved and, because of the shape of the bit 10, it is easy for the spinning bit 10 to engage an adjacent tooth, causing damage thereto. Therefore, there is a need for improved drill bit or drilling device for preparing a tooth for receiving a crown.

The impression of the prepared tooth is made and sent to the lab technician. The dentist makes and installs a temporary crown for the prepared tooth so the patient can function in a relatively normal manner while the permanent crown is being fabricated.

One important, but often overlooked, element of making the impression after the tooth is prepared is to obtain an accurate impression of the prepared tooth at and below the gum line. To achieve this goal, gingival cord, which is similar to thick dental floss, is wedged below the gum line in the free gingival area slightly below the area where the tooth has been prepared. An illustration of this technique is provided in FIG. 2, which shows a sectional view of the cord 13 wedged between the gum line 14 and shoulder 15 of the prepared tooth 16. This cord 13 will retract the gum and allow the impression material to go under the gum and provide an accurate impression of the margin of the prepared tooth.

The proper installation of the gingival cord 13 is extremely difficult. The dentist must essentially wedge the cord 13 around the tooth 16, maintain pressure on the cord 13 and pull the cord downward to separate the gum line 14 from the shoulder 15 of the tooth 16. Skill and experience is required to effectuate this step, but even when successful, can result in discomfort for the patient and it is time consuming. Therefore, there is a need for an improved means for fast and practical application of gingival cord between the tooth and the gum in preparation for taking an impression for a permanent crown mold.

Thus, this application is directed toward two parts of the crown restoration process: tooth preparation, or more specifically, forming a truncated conical surface from the tooth for receiving a permanent crown; and impression taking, which requires inserting gingival cord between the gum line and tooth prior to taking an impression of the prepared tooth.

### SUMMARY OF THE DISCLOSURE

In satisfaction of the aforenoted needs, and improved dental drill bit is disclosed for preparing a tooth for receiving a crown. The improved drill bit comprises a stem connected to a truncated conical body. The truncated conical body comprises an upper disc that is connected to the stem and which comprises an outer periphery connected to a downwardly extending sidewalls or bars. The downwardly extending sidewall being of a truncated conical configuration and terminating in a continuous lower edge. The lower edge having a diameter that is greater than a diameter of the outer periphery of the upper disc.

In a refinement, the lower edge and undersurface of the truncated conical body also provide a drilling or grinding surface. Preferably, the lower edge is tapered and comprises a curved inner portion. The lower edge and undersurface are preferably coated with an abrasive material such as diamond particles.

In a refinement, the sidewall comprises at least one opening that permits the entry and exit of cooling water. More preferably, a sidewall comprises a plurality of openings permitting circulation of cooling water.

In a related refinement, the upper disc comprises an opening for the circulation of cooling water. The upper disc may also comprise a plurality of such openings.

In another refinement, the disclosed dental drill bit has a cage-like structure.

A method is also disclosed for preparing a tooth for installation of a dental crown. The disclosed method comprises providing a plurality of truncated conical drill bits as described above, wherein the plurality of truncated conical drill bits are provided in a plurality of different sizes. Next, the size of the tooth in need of repair is measured using a gauge. The gauge is marked with numerical indicia indicative of one of the plurality of sizes associated with the plurality truncated conical drill bits. Then, using the size measurement obtained by use of the gauge, one of the plurality of truncated conical drill bits is selected. Using the selected drill bit, a truncated conical receiving surface is formed on an upper portion of the tooth.

An improved dental tool for the application of gingival cord in preparation for obtaining an impression used in the fabrication of a dental crown is disclosed. The gingival cord application tool comprises an elongated handle comprising two oppositely directed ends. At least one of the ends is connected to a gingival cord loop. In use, the gingival cord loop may be placed over a tooth and the handle may be twisted to tighten the gingival cord loop around the tooth and downward pressure may be applied on the handle to force the gingival cord loop between the tooth and gingiva and below the gum line.

In another refinement, a tool comprises an instrument for cutting the gingival cord. More specifically, a tool may comprise an upper prong with a hole or opening through which a gingival cord loop extends and a lower prong used for cutting the gingival cord loop. Of course, the functions of the upper and lower prongs may be reversed and the prongs may be disposed on opposing sides. In short, the orientation of the prongs is not important. In this embodiment, rotation of the handle is optional and not necessary.

In a refinement, the tool is disposable and intended for a single use.

A method for preparing a tooth and gum prior to taking an impression used for fabricating a dental crown is disclosed. The disclosed comprises shaping an upper portion of the tooth into a truncated conical surface using a truncated conical drill bit as discussed above. Then, the gingival cord application tool as described above is used to place a loop of gingival cord around the prepared tooth. Then, the handle of the dental tool is twisted about its axis to tighten the loop of gingival cord around the prepared tooth. And, downward pressure is applied on the handle and gingival cord thereby forcing the gingival cord into a space between the tooth and gum or gingiva below the truncated conical surface of the upper portion of the tooth and below the gum line.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a partial perspective view of a dental drill tool coupled to a burr-type drill bit used to prepare teeth for crown installation.

FIG. 2 is a partial sectional view of a tooth and adjacent gingiva illustrating the placement of gingival cord below the gum line and shoulder of the truncated conical crown receiving surface formed on the tooth.

FIG. 3 is a partial sectional and perspective view of a disclosed truncated conical-shaped drill bit as disposed over a tooth in need of repair.

FIG. 4 is a sectional view of a disclosed drill bit and tooth.

FIG. 5 is a perspective view of a disclosed drill bit coupled to a dental drilling tool.

FIG. 6 is a bottom perspective view of a disclosed drill bit.

FIG. 7 is a bottom plan view of the drill bit shown in FIG. 6.

FIG. 8 is a plan view of a gauge used to measure a tooth in need of repair for purposes of selecting an appropriate size for a truncated conical drill bit as illustrated in FIGS. 3-7.

FIG. 9 is a perspective view of a gingival cord application tool used to assist the dentist in placing gingival cord in a position as shown in FIG. 2.

FIG. 10 is a perspective view of another gingival cord application tool.

FIG. 11 is a perspective view of the upper prong of the gingival cord application tool shown in FIG. 10.

FIG. 12 is a perspective view of the lower cutting prong of the gingival cord application tool shown in FIG. 10. Thus

FIGS. 13-15 illustrate the use of the gingival cord application tool shown in FIGS. 10-12 as the cord is looped around a tooth (FIG. 13), as the upper and lower prongs are moved along the handle towards the tooth to tighten the cord loop around the tooth (FIG. 14), and as the cord is being cut (FIG. 15).

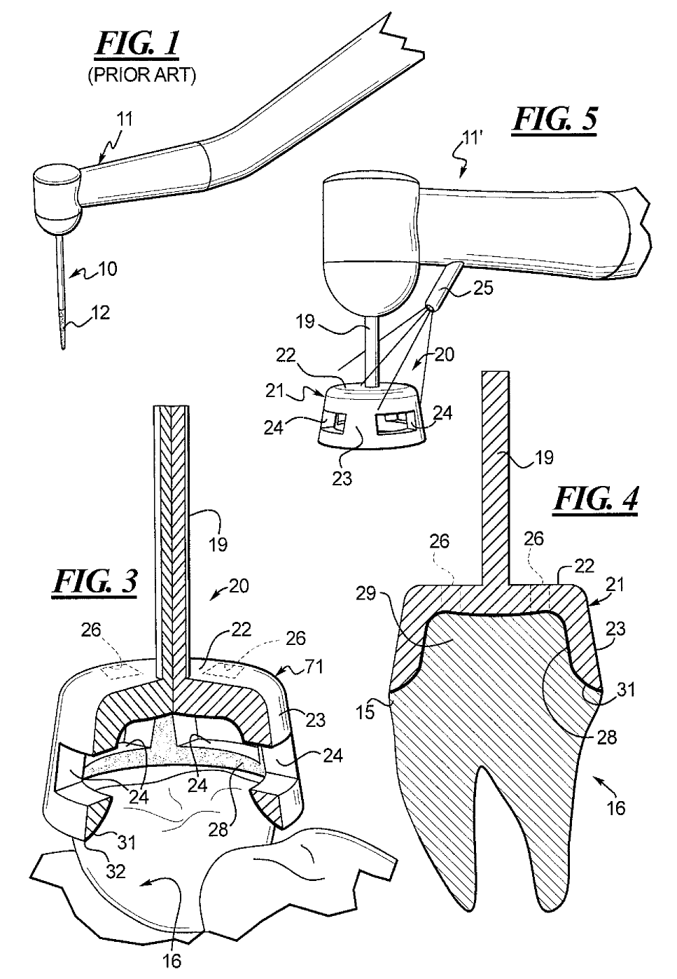

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

Turning first to FIG. 3, a drill bit 20 is disclosed which includes a stem 19 connected to a truncated conical body 21. The truncated conical body 21 includes an upper disc 22 and a continuous sidewall 23. A sidewall 23 and may include one or a plurality of openings 24 to permit the ingress and egress of cooling water supplied by the nozzle 25 of the dental tool 11′ shown in FIG. 5. Additionally, the upper disc 22 portion of the truncated conical body 21 may also include events or openings shown in phantom at 26 in FIGS. 3-4. The truncated conical body 21 may also be solid and configuration, although a more frequent flushing of the work surface on the tooth 16 will be required. Further, the drill bit 20 may be provided in a cage-like structure to permit substantial circulation of cooling water through the sidewall 23 and upper disc portion 22 of the truncated conical body 21.

Turning to FIG. 4, the under surface 28 of the truncated conical body 21 is covered or coated with abrasive material. Preferably, this abrasive material comprises diamond particles. The downwardly extending sidewall 23 terminates at a tapered lower edge shown at 31. It will be noted that the abrasive or diamond coating of the under surface 28 and a lower edge 31 terminates at the junction 32 between the outer and inner surfaces of the downwardly extending wall 23. In other words, the exterior surface of the wall 23 is not coated with abrasive material.

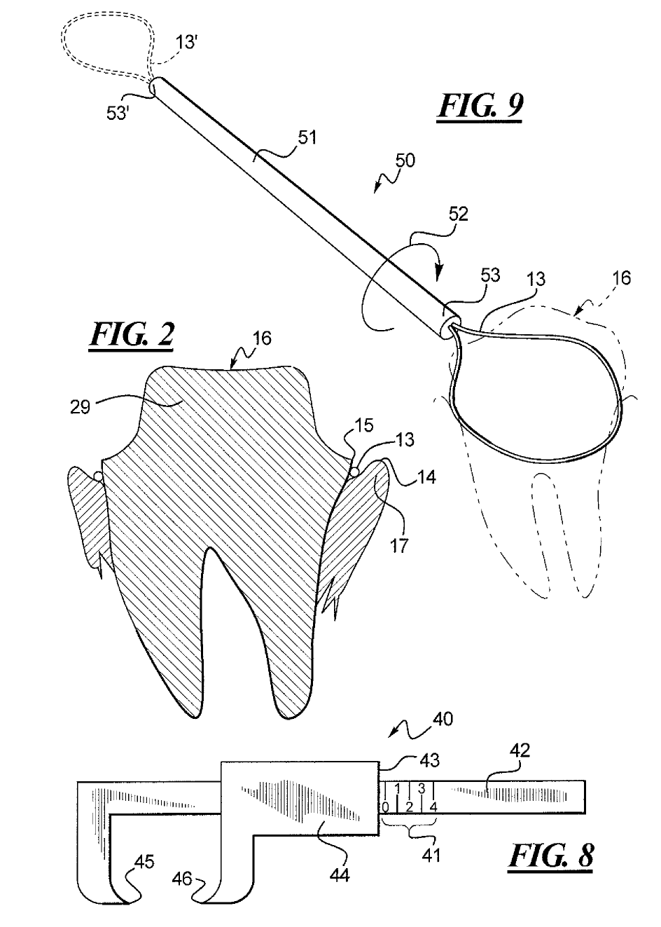

The drill bit 20 as shown in FIG. 4 is used to quickly and easily shape the upper portion 29 of the tooth 16 into a truncated conical configuration as shown in FIGS. 2 and 4, which is ideal for receiving a dental crown (not shown). The advantages of the drill bit 20 over the prior art drill bit 10 are clearly evident. Using the drill bit 10 to shape the upper portion 29 of the tooth 16 into the truncated conical shape shown in FIGS. 2 and 4 requires a great deal of skill and practice. Further, the drill bit 10 is hard to control and engagement of the drill bit 10 with adjacent or nearby healthy teeth is common, thereby causing damage to the adjacent healthy teeth and discomfort to the patient. Using the drill bit 20 as shown in FIGS. 3-7, a properly sized drill bit 20 can be placed over a tooth 16 and downward pressure may be applied to quickly form the truncated conical shaped upper surface 29 as shown. Fast dental procedures are advantageous to dentists because they can serve more patients per hour or per day and faster dental procedures are obviously more preferable to the patient.

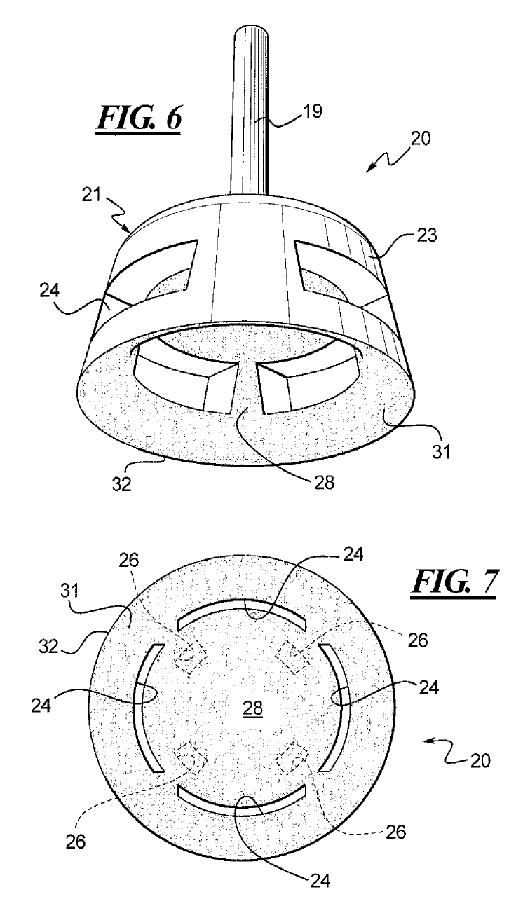

Turning to FIG. 3, it will be noted that the tapered lower edge 31 has a curved or arcuate inner surface. This is also evident from the tooth profile shown in FIG. 2. However, different profiles or configurations of the shoulder 15 of the prepared tooth 16 will be apparent to those skilled in the art. Further, as seen in FIGS. 6-7, the spacing of the vents or openings 24, 26 may vary and as indicated above, the entire truncated conical body 21 may have a cage-like configuration to permit maximum circulation of cooling water during the drilling or tooth preparation process.

Turning to FIG. 8, a gauge 40 is used to measure the size of a tooth in need of repair. The tooth size is measured so that the appropriate size drill bit 20 can be selected. Proper selection of the drill bit 20 size enables a quick and fast to the preparation process without the dentist needing to change tools or bits. The configuration of the gauge 40 may vary but a preferred embodiment includes simple numerical size indicia 41 disposed along the stationery element 42 with the rear edge 43 of the sliding element 44 providing an indication as to which drill bit size is necessary. The stationery element 42 and the sliding element 44 each include inwardly directed gripping elements 45, 46 respectively for receiving the tooth that is being measured. Thus, the indicia 41 are preferably indicative of drill bit sizes, not actual physical measurements. As a result, a plurality of drill bits 20 may be sold as a kit with anywhere from three to ten different size truncated conical drill bits 20.

As shown in FIGS. 2 and 9, an improved tool 50 is disclosed for the application of gingival cord 13 between the shoulder 15 of the tooth 16 and the gingiva 17, below the gum line 14. Rather than trying to manipulate the cord 13 by hand into this space, a simple loop may be provided at the end of a handle 51 and, to tighten the loop of court 13 around the tooth 16 the dentist merely twists the handle 51 about its axis as indicated by the arrow 52. The procedure is a marked improvement over the dentist using his/her fingers to wedge the cord 13 in place as normally both hands are required which is uncomfortable for the patient. In an alternative embodiment, either end of the handle 51 may include a loop of gingival cord 13, 13′ as shown in FIG. 9. Further, the entire applicator 50 is preferably designed to be disposable and therefore is intended for a single use. Thus, the handle 15 can be fabricated from lightweight plastic. The gingival cord loops 13 may be molded into the opposing ends 53, 53′ of the handle 51.

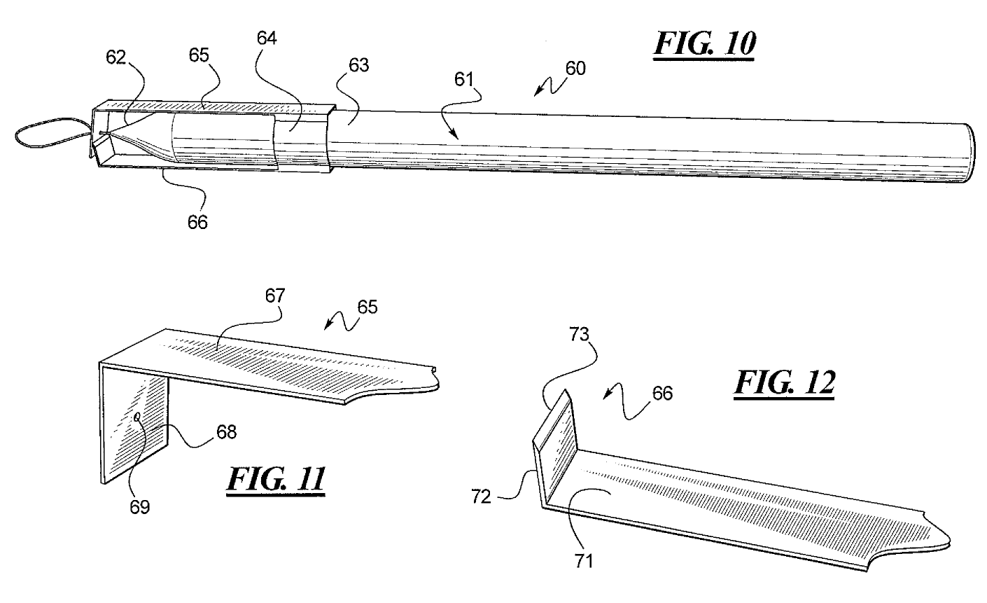

FIGS. 10-15 illustrate another gingival cord application tool 60 which includes a handle 61 connected to a gingival cord loop 62. The distal and 63 of the handle 61 accommodates a sleeve 64. The sleeve 64 is connected to an upper prong 65 and a lower prong 66. Turning to FIG. 11, the upper from 65 includes a flat section 67 connected to a perpendicular section 68. The perpendicular section 68 includes an aperture or hole 69 through which a loop 62 of gingival cord is fed as shown in FIG. 10. Thus, the upper prong 65 serves as a guide for the gingival cord loop 62. Turning to FIG. 12, the lower prong 66 includes a flat section 71 connected to a perpendicular section 72 which terminates at a cutting edge 73.

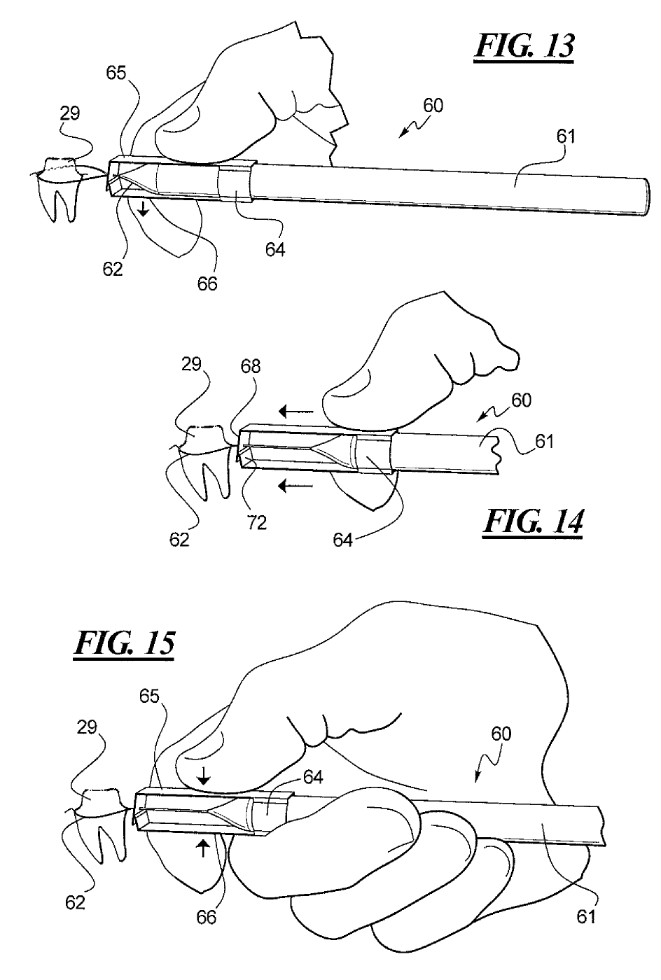

Turning to FIGS. 13-15, the cord loop 66 is first looped over a tooth 29 and shown in FIG. 13. As shown in FIG. 14, the dentist then pushes the sleeve 64 towards the tooth 29 so that the perpendicular sections 68, 72 abut the side of the tooth 29. This operation illuminates or reduces the need to the dentist to spin a handle 61 in a manner similar to that shown for the embodiment 50 of FIG. 9. With the perpendicular sections 68, 72 against the tooth 29, the upper and lower prongs 65, 66 are then squeezed together a shown in FIG. 15 and the cord loop 62 is cut.

While only certain embodiments have been set forth, alternatives and modifications will be apparent from the above description to those skilled in the art. These and other alternatives are considered equivalents and within the spirit and scope of this disclosure and the appended claims.

What is claimed:

1. A dental tool for the application of gingival cord, the tool comprising:
an elongated handle comprising two oppositely directed ends, at least one of the ends being connected to a gingival cord loop,
the end of the handle connected to the gingival cord loop being slidably received within a sleeve, the sleeve connected to two opposing prongs,
each prong comprising a first section disposed essentially parallel to an axis of the handle and a perpendicular section extending inwardly towards the axis of the handle, one of the perpendicular sections of one of the prongs comprising a guide through which the gingival cord loop extends and the other of the perpendicular sections terminating at a cutting edge, the perpendicular section with the cutting edge being directed at the perpendicular section comprising the guide,
whereby the gingival cord loop may be placed over a tooth and the sleeve may be slid towards the tooth thereby tightening the loop around the tooth as the guide approaches the tooth and downward pressure may be applied on the handle to force the gingival cord loop between the tooth and gum and below the gum line and the prongs may be squeezed towards one another thereby cutting the loop at the guide with the cutting edge.

2. The dental tool of claim 1 wherein at least one of the prongs is flexible thereby enabling the perpendicular sections to be squeezed towards one another and allowing the cutting edge to cut the gingival cord loop at the guide.

3. The dental tool of claim 1 wherein the guide comprises a hole through which the gingival cord loop extends.

4. The dental tool of claim 1 wherein the tool is disposable.

5. The dental tool of claim 1 wherein both prongs are flexible.

6. The dental tool claim 1 wherein both prongs and a sleeve are unitary in construction and fabricated from stainless steel.

7. The dental tool of claim 1 wherein the prongs are parallel to each other.

8. The dental tool of claim 1 wherein the prongs and the axis of the handle are all parallel to each other.

9. A method for preparing a tooth and gum prior to taking an impression used for fabricating a dental crown, the method comprising:
shaping an upper portion of the tooth into a truncated conical surface,
using the dental tool of claim 1 to place a loop of gingival cord around the tooth,
pushing the sleeve towards the tooth until the perpendicular sections of the prongs abut the tooth to tighten the loop of the gingival cord around the tooth,
applying downward pressure on the handle and gingival cord thereby forcing the gingival cord into a space between the tooth and gum below the truncated conical surface of the upper portion of the tooth, and
squeezing the prongs together to cut the gingival cord loop.
